(19) United States
(12) Patent Application Publication
(10) Pub. No.: US 2025/0244301 A1
(43) Pub. Date: Jul. 31, 2025

(54) CHARACTERIZING A PROPERTY OF A FLOW PATH OF AN ANALYSIS DEVICE

(71) Applicant: Agilent Technologies, Inc., Santa Clara, CA (US)

(72) Inventors: Thomas Ortmann, Straubenhardt/Ottenhausen (DE); Blasius Nocon, Rheinstetten (DE)

(21) Appl. No.: 19/040,793

(22) Filed: Jan. 29, 2025

(30) Foreign Application Priority Data
Jan. 31, 2024 (DE) 102024102748.7

(51) Int. Cl. G01N 30/88; G01N 30/32

(52) U.S. Cl. CPC G01N 30/88; G01N 30/32; G01N 2030/326; G01N 2030/328; G01N 2030/8804

(57) ABSTRACT

In a method for characterizing a property of a flow path, in particular of an element in the flow path, in an analysis device, the volume of a fluid in the flow path, in particular in the element of the flow path, is changed in order to change the pressure in the flow path. The pressure change in the flow path as a consequence of the volume change is determined. The property of the flow path is characterized based on the determined pressure change and/or the volume change.

### CROSS-REFERENCE TO RELATED APPLICATIONS

The present application claims the benefit of German Patent Application No. DE 10 2024 102 748.7, filed on Jan. 31, 2024, which is incorporated herein by reference in its entirety.

### TECHNICAL FIELD

The present disclosure relates to a method for characterizing a property of a flow path or an element in the flow path, in an analysis device. The method comprises: Changing the volume of a fluid in the flow path, in particular in the element of the flow path, in order to change the pressure in the flow path, determining the pressure change in the flow path as a consequence of the volume change, and characterizing the property of the flow path based on the determined pressure change and/or the volume change. The present disclosure further relates to an analysis device.

### BACKGROUND

Analysis devices are, for example, chromatography devices, in particular sample separation devices, intended for the analysis of a sample, in particular a fluidic sample, for example, for carrying out a chromatographic separation of the sample.

In an HPLC (high-performance liquid chromatography) device (or system), for example, a liquid (mobile phase) is moved at a very precisely controlled flowrate (for example, in the range of microliters to milliliters per minute) and at a high-pressure (typically 20 to 1000 bar and beyond, currently up to 2000 bar), at which the compressibility of the liquid can be noticeable, through a so-called stationary phase (for example, in a chromatographic column), in order to separate single fractions from one another of a sample liquid injected into a mobile phase. After passing the stationary phase the separated fractions of the fluidic samples are detected by a detector. Such an HPLC system is known, for example, from EP 0,309,596 B1 of the same applicant, Agilent Technologies, Inc.

Analysis devices such as the HPLC device are usually highly precise devices and therefore, regarding the operation, particularly high standards apply with respect to reliability. Regarding the often very complex connections of the flow paths in an analysis device, this can certainly be a challenge. For example, if an element (such as a sample loop) is switched into a flow path (fluidically coupled), the element needs to be known exactly (for example, the type, intake volume, etc.). In particular, it needs to be verified that the correct element is arranged or coupled at the correct position.

Regarding the configuration of single elements in the flow path, assignment errors can easily occur. Often connections or verifications need to be performed manually, whereby the operating effort as well as the susceptibility to errors increase. Further, by the conventional approach, a remote operation of the analysis device is made considerably more difficult, because the user cannot simply open the analysis device from outside and verify the arrangement of the elements regarding the flow path.

Conventionally, different tags are used to label or distinguish components, for example. For this, barcodes, color codes, or a read-out by means of RFID (radio-frequency identification) can be used, for example. Regarding the complexity of the configuration of the analysis device, such tags can though restrict the clarity further or increase the complexity. Furthermore, such tags are only suitable to a very limited extent for a remote operation of the analysis device.

### SUMMARY

There can be a need to characterize a property of a flow path or of an element in the flow path of an analysis device efficiently and reliably.

In the following, a method, a device for data processing, an analysis device, and a use are described.

According to a first aspect of the present disclosure a method (in particular a computer-implemented method) for characterizing a property (e.g., a configuration) of a flow path, in particular of an element (e.g., a sample loop) in the flow path, in an analysis device is described, wherein the method comprises:
i) changing the volume of a fluid (e.g., water) in the flow path, in particular in the element of the flow path, in order to change the pressure in the flow path (e.g., by compressing or changing the temperature);
ii) determining the pressure change (e.g., by means of a pressure sensor and/or based on the adjusted pressure) in the flow path (in particular in the element in the flow path) as a consequence of the volume change; and
iii) characterizing the property of the flow path based on the determined pressure change and/or the volume change (here a direct relationship between pressure change and volume change can exist).

According to a second aspect of the present disclosure, a device for data processing is described, which comprises a processor or additionally a memory, and which is configured to carry out the method as described above.

According to a third aspect of the present disclosure, an analysis device for carrying out an analysis method is described, wherein the analysis device comprises a device for data processing as described above.

According to a fourth aspect of the present disclosure, a use of a fluid drive device (in particular a dosing or metering pump) is described, for compressing a fluid in a flow path, in order to characterize, based on a volume change and/or a pressure change of the fluid in the flow path, a property of the flow path and/or of an element in the flow path.

In the context of the present disclosure, the term “analysis device” can designate in particular a device, which is capable and configured to examine a fluidic sample, in particular to separate the fluidic sample, further in particular to separate the fluidic sample into different fractions. For example, such a sample separation can occur by means of chromatography or electrophoresis. The analysis device may be a liquid chromatography separation device. The analysis device is in particular configured to carry out an analysis method or a (if necessary planned or programmed) sequence of analysis methods or procedures. Further, the term “analysis method” can be used as representative for a sequence, a program, an execution list of analysis methods, procedures or instructions, including adaptation, preparation, equilibration (intermediate) steps, and the like.

In the context of the present disclosure, the term “fluidic sample” can designate in particular a medium, further in particular a liquid, which contains the matter to be analyzed (for example, a biological sample), for example, a protein solvent, a pharmaceutical sample, etc.

In the context of the present disclosure, the term “mobile phase” can designate in particular a fluid, further in particular a liquid, which serves as a carrier medium for transporting the fluidic sample between a fluid drive and a sample separation device. Mobile phase can also be used in a fluid conveyer device for influencing the fluidic sample. For example, the mobile phase can be a (for example, organic and/or inorganic) solvent or a solvent composition (for example, water and ethanol).

In the context of the present disclosure, the term “element” can designate in particular a device/a unit/a fluid line, which fulfils a function in an analysis device, in particular a function that is associated with performing the analysis. In one example, the element is associated with a flow path/fluid path, e.g., coupled or couplable in a flow path between a fluid drive and a detector. In one example, the element can comprise a sample intake device or a sample separation device (e.g., a chromatographic separation column). In another example, the element can designate a (part of a) flow path, e.g., a channel or a capillary. Further, a functional element can be, e.g., a valve, a damper, a loop, a mixer or a filter.

According to an exemplary embodiment, the present disclosure can be based on the idea that a property of a flow path or an element in the flow path of an analysis device can be characterized efficiently and reliably, if a volume change (regarding the fluid in the flow path) is triggered (e.g., by compression or temperature change) and then a pressure change caused by the volume change is determined. Based on this change, a property can be inferred, so that a characterizing (e.g., identifying, distinguishing, verifying) is enabled.

In a specific embodiment, sample loops are distinguished according to their inner volume. This can be determined by compressing the flow path to a certain pressure, and the compressed volume is compared with volumes which relate to different types of sample loops at the same pressure.

The described method can be directly implemented in existing and established systems without substantial modifications. For generating of the volume change (e.g., compression), for example, a pump of the analysis device can be used directly. Further elements such as valves can be used to close a flow path to enable a compression. Further functions such as determination of compressibility of the fluid can be implemented directly and easily.

Advantageously, a corresponding analysis device can be operated efficiently in a remote operation, because the characterizing can be performed automatically, without the need of opening the analysis device manually to check the elements in the flow path.

### Exemplary Embodiments

Additional embodiments are described below.

According to an embodiment, the method comprises: (at least partially) closing of an inflow and/or an outflow of the flow path. According to an embodiment, the method comprises: (at least partially) closing at least a part/section of the flow path, which can enable a particular efficient volume change/pressure change. For example, the flow path can by means of a valve or of another blocking element be blocked or closed. Also, a narrowing of the flow path can represent a closing. If the flow path, e.g., behind a sample loop (as an element of the flow path) is closed, an enclosed fluid can then be compressed quickly and efficiently, whereby the volume change and the (detectable) pressure change can be provided.

According to an embodiment, the volume change (of the fluid) comprises a volume reduction. For example, the fluid (in the flow path/element) can be compressed via a pressure (e.g., by a pump piston). In another embodiment, the change of temperature can decrease the volume of the fluid. According to an embodiment, the pressure change comprises a pressure increase. In particular, by a compression of the fluid, the pressure of the fluid increases and subsequently also within the flow path/element. The same applies at a volume change by means of the temperature. In this way, volume change and the resulting (detectable) pressure change can be directly connected with each other.

According to an embodiment, the determining of the pressure change comprises a pressure measurement, in particular by means of a pressure sensor. Thus, the determining of the pressure (as measurand) can be implemented directly, reliably, and with established means. In analysis devices such as a HPLC devices, pressure plays an important role, so that usually many pressure sensors are available in the device. However, also a flow path or the element in the flow path can be equipped in an easy way directly with a pressure sensor. In another example, the pressure change can also be determined via a (indirect) volume measurement.

According to an embodiment, the changing of the volume comprises a compressing and/or a temperature change, in particular a heating or cooling. In an example, devices can be used for this, which are already available at the analysis device. For example, the pressure can be built up by means of a pump, e.g., a dosing (or metering) device or a fluid drive. In another example, a temperature chamber (e.g., a temperature-controlled sample handling room or a column oven) for changing the temperature can be used or repurposed.

According to an embodiment, the characterizing comprises at least one of the following regarding the flow path (in particular of the element in the flow path): a verification, an identification, a mapping, an assigning, a distinguishing, a positioning-determining, a determining of a wiring. This allows determining various aspects of the configuration of the analysis device directly and reliably.

In an example, it can be verified, if the correct element is present and/or arranged/coupled at the correct position. The active (in the flow path of the analysis device coupled) element can be (as such) identified. In an example, several elements can be observed (e.g., the pressure is determined several times (in succession) regarding different elements), so that each position can be assigned an element or reversed (mapping). In an example, an element based on a detected pressure change at a certain position in the analysis device and/or at a certain switching position can be assigned. In an example, two or more elements (e.g., sample loops with different volumes) can be distinguished from one another by the described method.

According to an embodiment, the property comprises at least one of the following regarding the flow path (in particular the element in the flow path): a volume, a size, or a type. Different flow paths or elements can differ in particular regarding (intake) volume, size (can correlate directly with volume), or type (can also correlate with volume/size). Exactly these important properties can be particularly efficient and reliable by means of the described determination of the pressure change determinable or distinguishable.

According to an embodiment, the characterizing of the property further comprises: comparing the determined pressure change and/or of the volume change with a reference property and/or a reference element. By means of a comparison with a reference, the characterizing can be performed particularly quickly and efficiently. In the example of a sample loop, reference values can be measured in advance, e.g., the relation of a volume change to determined/measured pressure change at a first volume (e.g., 40 μL) and a second volume (e.g., 100 μL). A comparison of a certain pressure change (or volume change) with the respective reference values can thus lead directly to the result as to which sample-loop volume (e.g., 40 μL or 100 μL) is present, and thus also allows the conclusion as to which sample loop type is currently used (or is currently connected).

According to an embodiment, the volume change, in particular the compression, is provided by means of a pump, in particular by means of moving a pump piston in a pump volume. According to an embodiment, the volume change, in particular the compression, is provided by means of a dosing (or metering) device, in particular a dosing (or metering) pump. This can result in the advantage that equipment of the analysis device which is already available can be used directly (or repurposed). In the examples of FIGS. 2 to 5, it is described that the dosing (or metering) device (or dosing or metering pump) of the analysis device is used for this. For dosing (or metering) the fluidic sample, the dosing (or metering) device comprises a pump volume (cylinder), in which a pump piston can be moved and fluid in the pump volume can be compressed (volume change). This volume change can have a direct effect on the flow path (e.g., a sample loop), which is coupled fluidically with the dosing (or metering) device. Accordingly, the measured pressure change can allow direct conclusions to a property of the flow path (or the sample loop). In another example, an analytical pump (drive of mobile phase, in particular with injected sample, for the sample separation device) or a flushing pump can be used.

According to an embodiment, the method comprises: estimating the volume change, in particular a value range for the volume change. While in one case the determining of the pressure change can lead to a precise specification of the property (e.g., inner volume), it may happen in other cases that the property based on the pressure change can be estimated only. Nevertheless, such an estimation can be extremely helpful. For example, if the question arises as to whether in a flow path a 40 μL sample loop or a 100 μL sample loop is coupled, an estimation of the property or the volume change can lead to a reliable result, in particular because the possible volumes are clearly separated from each other.

In the context of this disclosure, the term “estimating” can in particular relate to a process in which a property (e.g., volume, volume change) is assigned and/or calculated, wherein the value/value range is not necessarily exact, but approximately determined. In particular, in the estimation can be included relevant data/information/parameter, which are available at the time of the estimation so that the result of the estimation comes as close as possible to the actual value/value range. The aim of the estimation is to achieve the best possible result based on the best available data. Thereby, the estimation can be distinguished both from a (exact) determining and a pure guessing.

According to an embodiment, the element in the flow path comprises at least one of the following: a sample intake device (e.g., a sample loop), several sample loops connected in parallel, a trap column, a valve, a capillary, a conduit, a channel, a fluid line, a filter, a mixer, a damper, and/or a (chromatographic) separating column. This can have the advantage that properties of many of technically or economically relevant units of an analysis device can be characterized directly in the flow path (in particular in-line) (substantially without modification).

According to an embodiment, the entire flow path or an area of the flow path is characterized. The flow path can, e.g., extend from a dosing (or metering) device to a sample separation device. Also, there can be characterized only one area of the flow path (or even an element or component in the flow path).

According to an embodiment, the flow path is arranged between a sample needle and the dosing (or metering) device. Such an example is described for FIG. 2. The element in the flow path can be, e.g., the sample loop, which stores drawn-in fluid. According to an embodiment, the flow path is arranged between the dosing (or metering) device and a sample separation device. Such an example is described for FIG. 5. The element in the flow path can thereby be the sample separation device itself, wherein the dosing (or metering) pump causes the volume change of the fluid.

According to an embodiment, the flow path is arranged between the sample needle and a fluid drive device, in particular an analytical pump. According to an embodiment, the flow path is arranged between a fluid drive device and a valve, in particular wherein the valve is switched such that the output of the flow path is at least partially closed. The (fluidic) valve can here be used efficiently (and without additional effort), in order to close an output (or input), whereby a volume change with a determinable/measurable pressure change can be provided. According to an embodiment, the flow path is arranged downstream of a fluid drive device, in particular wherein the flow path is at least temporarily closed at one end. The fluid drive device can be (similar to the above-described dosing or metering pump) used in order to provide a volume change or a pressure increase.

According to an embodiment, the fluid (a liqid or a gas) comprises at least one of the following: water, in particular highly pure water, further in particular ultra highly pure water, an organic solvent, a sample fluid, a mobile phase, the sample fluid injected into the mobile phase, or a gas, in particular air. Dependent on the flow path and application, many fluids can be used. This can result in a particular flexibility.

According to an embodiment, the compressibility of the fluid is known. Based on the compressibility, it can be concluded particularly reliable from the determined pressure change to the property.

According to an embodiment, the method comprises: determining the compressibility of the fluid in the flow path, in particular in-line. In this advantageous embodiment, the compressibility of the fluid can be directly (during operation) determined/measured in the analysis device. This procedure can be particularly relevant when the compressibility of the fluid is not known (e.g., organic solvent).

According to an embodiment, the determining of the compressibility comprises (in particular performed by means of a dosing (or metering) device, see detailed description regarding the FIGS. 3A to 3D):
i) determining a first volume difference (AV) and a first pressure difference (AP) at a first position (e.g., regarding the pump piston); and/or
ii) determining a second volume difference (AV) and a second pressure difference (AP) at a second position (e.g., further movement of the pump piston);
iii) determining the compressibility based on the first volume difference, the first pressure difference, the second volume difference, and the second pressure difference.

By means of this embodiment, the compressibility can be determined via a two-point-measurement efficiently and reliably.

According to an embodiment, the type of fluid is determined based on the (determined) compressibility. This can be particularly advantageous when the fluid is to be verified or identified in the flow path. For example, the organic solvents of the mobile phase (e.g., methanol or acetonitrile) can be distinguished or identified based on the compressibility (measurement).

According to an embodiment, the characterizing is carried out by means of an absolute measurement value or by means of a relative measurement value. According to an embodiment, the method regarding the analysis device is non-invasive. According to an embodiment, available equipment is used for the method. According to an embodiment, the method is carried out (substantially) without a human operator. According to an embodiment, the method regarding the analysis device is carried out in a remote operation. These aspects can implement the described method particularly efficiently and favorably.

According to an embodiment, the analysis device (or system) is configured as a sample separation device (or system). According to an embodiment, the analysis device comprises a fluid drive for driving a mobile phase and a fluid sample injected into the mobile phase. According to an embodiment, the analysis device comprises a sample separation device (or unit) for separating the fluid sample injected into the mobile phase. According to an embodiment, the analysis device is configured for analyzing at least a physical, chemical and/or biological parameter of the fluidic sample. According to an embodiment, the analysis device is configured as a sample separation device for separating the fluidic sample.

In the context of this application, the term “sample separation device” or “sample separation system” can designate a device for analyzing of a fluidic sample, in particular in different fractions. For this purpose components of the fluidic sample can be initially adsorbed and then separately (in particular fractionally) desorbed in the sample separation device or unit. For example, such a sample separation device or unit can be configured as chromatographic separation column.

According to an embodiment, the analysis device or system can be a chromatography device, in particular a fluid chromatography device, a gas chromatography device, an SFC (super critical liquid chromatography) device, or an HPLC (high-performance liquid chromatography) device.

According to an embodiment, the analysis device is configured as a microfluidic device. According to an embodiment, the analysis device is configured as a nanofluidic device.

According to an embodiment, the sample separation device or unit is configured as chromatographic separation device or unit, in particular as a chromatography separation column.

According to an embodiment, the fluid drive is configured for driving the mobile phase and the fluidic sample under high pressure.

According to an embodiment, the fluid drive is configured for driving the mobile phase and the fluidic sample at a pressure of at least 500 bar, in particular of at least 1000 bar, further in particular of at least 1200 bar, further in particular of at least 1500 bar.

According to an embodiment, the analysis device comprises a detector for detecting the analyzed, in particular separated, fluidic sample.

According to an embodiment, the analysis device comprises a fractionator for fractionating separated fractions of the fluidic sample.

The analysis device can be a microfluidic measurement device, a life-science device, a liquid chromatography device, a gas chromatography device, an HPLC (high-performance liquid chromatography) device, a UHPLC (ultra-high-performance liquid chromatography) device, or an SFC (super critical liquid chromatography) device. However, there are many different other applications possible.

According to an embodiment, the sample separation device or unit can be configured as chromatography separation device, in particular as a chromatography separation column. For a chromatography separation, the chromatography separation column can comprise an adsorption medium. At this, the fluidic sample can be stopped and can only be subsequently removed fractionally by a specific solvent composition, with which the separation of the sample in its fractions is accomplished.

A pump system for conveying of fluid can, for example, be configured such that the fluid or the mobile phase is conveyed through the system with a high pressure, for example, several 100 bar to 1000 bar and beyond. The analysis device can comprise a sample injector for inserting the sample into the fluidic separation sample path. Such a sample injector can comprise a sample or injection needle in a liquid path which can be coupled with a needle seat, wherein the sample needle can be driven out from the needle seat to pick up the sample. After the sample needle is re-inserted into the needle seat, the sample can be in the fluid path, which, for example, through switching of a valve, can be switched into the separation path of the system. In another embodiment of the present disclosure, the sample injector or sampler with a sample needle can be used, which is operated without a needle seat.

The analysis device can comprise a fraction collector for collecting the separated components. Such a fraction collector can guide the various components of the separated sample, for example, to various liquid containers. The analyzed sample can also be guided to a drainage container (or waste).

The analysis device may comprise a detector for detecting the separated components. Such a detector can generate a signal, which can be observed and/or recorded, and which is indicative for the presence and amount of sample components in the fluid which flows through the system.

According to an exemplary embodiment, a sampling space is restricted by means of a housing in which the sample handling arrangement or the sample movement device is arranged.

Embodiments of the present disclosure may be partly or entirely embodied or supported by one or more suitable software programs or products, which can be stored on or otherwise provided by any kind of non-transitory medium or data carrier, and which might be executed in or by any suitable data processing unit such as an electronic processor-based computing device (or system controller, controller, control unit, device for data processing, etc.) that includes one or more electronic processors and memories. Software programs or routines (e.g., computer-executable or machine-executable instructions or code) may be applied in or by the control unit, e.g. a data processing system such as a computer, such as for executing any of the methods described herein. For example, one embodiment of the present disclosure provides a non-transitory computer-readable medium that includes instructions stored thereon, such that when executed on a processor, the instructions perform the steps of the method of any of the embodiments disclosed herein.

### BRIEF DESCRIPTION OF THE DRAWINGS

Other objectives and many of the attendant advantages of embodiments of the present disclosure will become readily appreciated and better understood with reference to the following more detailed description of embodiments in connection with the accompanying drawings. Features which are substantially or functionally the same or similar are designated by the same reference signs.

FIG. 1 shows an analysis device or system configured as a chromatography device or system, according to an exemplary embodiment of the present disclosure.

FIG. 2 shows schematically a first configuration of the analysis device, according to an exemplary embodiment of the present disclosure.

FIG. 3A shows a determining of the compressibility of the fluid, with a pump piston located at a certain position in a pump volume, according to an exemplary embodiment of the present disclosure.

FIG. 3B shows a determining of the compressibility of the fluid, with the pump piston located at a different position in the pump volume, according to an exemplary embodiment of the present disclosure.

FIG. 3C shows a determining of the compressibility of the fluid, with the pump piston located at a different position in the pump volume, according to an exemplary embodiment of the present disclosure.

FIG. 3D shows a determining of the compressibility of the fluid, with the pump piston located at a different position in the pump volume, according to an exemplary embodiment of the present disclosure.

FIG. 4A shows a volume and pressure change regarding a sample storing device, according to an exemplary embodiment of the present disclosure.

FIG. 4B shows a volume and pressure change regarding a different sample storing device, according to an exemplary embodiment of the present disclosure.

FIG. 5 shows schematically a second configuration of the analysis device or system, according to an exemplary embodiment of the present disclosure. The illustrations in the drawings are schematic.

### DETAILED DESCRIPTION

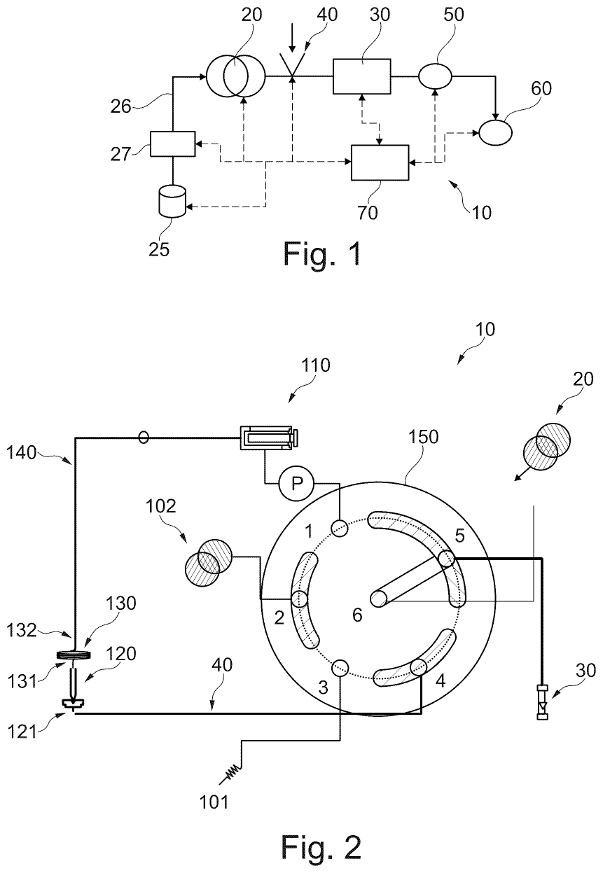

FIG. 1 shows a principal structure of a HPLC system as an example for an analysis device (or system) 10 which is configured as a sample separation device (or system) or chromatography device (or system), according to an exemplary embodiment of the present disclosure, as it can be used, for example, for liquid chromatography. A fluid conveying device or a fluid drive 20 which is supplied with solvents from a feeding device 25 (or consumable material from a container), drives a mobile phase through a sample separation device or unit 30 (such as, for example, a chromatography column), which comprises a stationary phase.

The solvents are here a consumer material which is stored in one or more containers 25. The feeding device comprises usually a first fluid component source (e.g., a first container) for providing a first fluid or a first solvent component A (for example, water) and a second fluid component source (e.g., a second container) for providing another second fluid or a second solvent component B (for example, an organic solvent).

An optional degasser 27 can degas the solvents which are provided by means of the first fluid component source and by means of the second fluid component source, before these are fed to the fluid drive 20. A sample supply unit, which can be designated as an injector 40 (sampler), is arranged between the fluid drive 20 and the sample separation device 30 in order to initially inject a sample fluid or a fluidic sample from a sample container to a sample intake volume in an injector path, and subsequently to insert it into a fluidic separation path between fluid drive 20 and sample separation device 30 by switching an injector valve.

The taking up of fluidic sample from a sample container can in particular occur such that initially a sample needle 120 is driven out from a sample seat and driven into the sample container. By means of a fluid drive device which is configured as a dosing (or metering) device 110, the fluidic sample can be sucked-in from the sample container via the sample needle 120 into the sample intake volume 130. Subsequently the sample needle 120 can be driven in a needle seat 121 of the analysis device 10 to inject the fluidic sample in the flow path of the analysis device 10.

The detector 50, which can comprise a flow cell, detects separated components of the sample. A fractioning device or a fractionator 60 can be intended for outputting separated components of the sample into intended containers. Liquids that are not anymore required can be output into a drainage container or a waste line.

While a fluid path between the fluid drive 20 and the sample separation device 30 is typically under high pressure, the sample liquid under normal pressure is initially injected in an area, namely the sample loop or the sample intake volume 130, which is separated from the fluid path. Subsequently, the sample fluid is brought into a separation path that is under high pressure. A sample loop as a sample intake device (also designated as sample loop) 130 can be understood to be a section of a fluid line, which is configured for picking up or intermediate storing of a predetermined amount of a liquid sample. Before the switching on of the sample liquid, which is initially under normal pressure in the sample intake volume 130, into the separation path, which is under high pressure, the content of the sample intake volume 130 may be brought to the system pressure of the analysis device 10, which is configured as an HPLC device, by means of the dosing (or metering) device 110 in the form of the fluid drive device. A control device or control system 70 controls the single components or elements 20, 25, 30, 40, 50, 60, etc., of the analysis device 10. Each of these components can comprise a separate housing, or two or more components can be arranged in the same housing.

FIG. 2 shows schematically a first configuration of the analysis device 10, according to an exemplary embodiment of the present disclosure. The connection succeeds here vividly via a fluid valve 150 in which the grooves are drawn between stator and rotor and the six connectors 1 to 6. As already described in FIG. 1, the dosing (or metering) device 110 (used as fluid drive device) is configured for sucking fluidic samples from the sample container by means of a sample needle 120 into a sample intake device/sample loop 130. After this, the sample needle 120 can be driven into the sample seat 121 of the analysis device 10, and there the fluidic sample can be injected into the analytical flow path (connected to valve position 4).

A further fluid drive device (analytical pump) 20 is connected fluidic via the high-pressure path with the sample separation device or unit 30 via valve-positions 5 and 6. The fluidic sample is (after injection in the needle seat 121) injected in principle into this high-pressure path, wherein in the shown configuration there is no direct fluidic connection between sample injector 40 and the high-pressure path switched. Another fluid drive device (flushing pump) 102 provides another flow path which leads (under normal pressure) to a liquid waste 101.

In a first example, the sample loop 130 is that element in the flow path 140 whose property (e.g., volume) should be characterized. A volume change (of the fluid in the sample loop 130) can be triggered by the dosing (or metering) pump 110, which compresses the fluid in the flow path 140. An inlet 132 or an outlet 131 of the sample loop 130 can be blocked in order to build up the pressure in the flow path 140.

In a second example, the sample separation device or unit 30 is that element in the flow path (here high-pressure path), which should be characterized. A volume change can be triggered by the analytical pump 20, which compresses the fluid in the high-pressure path. Thereby it can be concluded on the volume (or another property) of the sample separation device or unit 30, so that this can be characterized.

In a specific embodiment, different sample intake volumes (e.g., sample loops 130) should be distinguished by their inner volumes. It can be concluded to this volume if the corresponding flow path is compressed to a certain pressure and the compressed volume (volume change) is compared with volumes (reference values) which relate to various types of sample intake volumes at the same pressure. To avoid errors regarding the compressibility, the compressibility of the fluid should be known or (in-line) be determined. The same can apply for the system elasticity. The term “system elasticity” can relate in this context in particular to the pressure-dependent expansion of flow path components (pumping head, capillary etc.) and the associated change of the system volume. The elasticity can be individual for each system or for each system configuration.

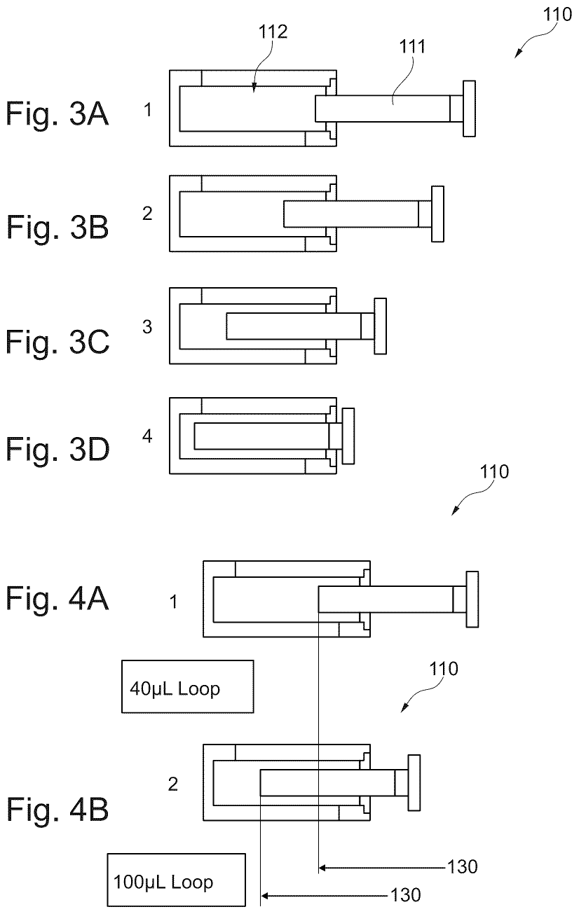

The FIGS. 3A to 3D show a determination of the compressibility directly in operation (in-line) of the analysis device 10, according to an exemplary embodiment of the present disclosure. Such determining can, e.g., be performed directly before the characterizing of the property. The following steps can be performed in this example, at which the dosing (or metering) pump 110 is used, which comprises a pump piston 111 and a pump volume 112:

FIG. 3A: In the starting position, the pump piston 111 is driven out far or to a maximum out of the pump volume 112. The pressure initially can be zero. There is a first volume V1 (sample volume not compressed) and a first pressure P1 (e.g., zero) present. The first volume V1 can be, e.g., 300 μL.

FIG. 3B: In a first compression step, the pump piston 111 is driven into the pump volume 112. The pressure increases to a second pressure P2 (e.g., 1000 bar) and the sample volume is reduced to a second volume V2 (e.g., 290 μL). From these measured values a first compressibility can be calculated: β1=−1/V((V2−V1)/(P2−P1)).

FIG. 3C: The second starting position can either be based on a position of the first compression determination (at V2, P2) or the pump piston 111 can be driven in further into the pump volume 112. In the second starting position, there is a third volume V3 (this can correspond to the second volume V2) and a third pressure P3 (this can correspond to the second pressure P2).

FIG. 3D: In a second compression step, the pump piston 111 is even further driven into the pump volume 112 (possibly to the maximum). The pressure increases to a fourth pressure P4 (e.g., again 1000 bar) and the volume is reduced to a fourth volume V4 (e.g., 281 μL). From these measured values a second compressibility can be calculated as follwos: β2=−1/V((V4−V3)/(P4−P3)).

A difference of the first compressibility and the second compressibility can lead in a reliable way by means of a two-point determination to the compressibility of the fluid: βS=β2−β1.

FIGS. 4A and 4B show a volume and pressure change regarding two different sample intake devices (not shown here) as elements to be characterized, according to an exemplary embodiment of the present disclosure. In FIG. 4A, a small sample loop with a volume of 40 μL is coupled to a dosing (or metering) device 110, while in FIG. 4B a larger sample loop with a volume of 100 μL is coupled to a (here of identical construction) dosing (or metering) device 110. In this example, water is used as the fluid in the flow path, whose compressibility is known. The pressure in the flow path in each case is increased by inserting the pump piston 111 into the pump volume 112, in both cases to 1000 bar. Thereby a volume change of the fluid (water) occurs and the fluid in the flow path is compressed by the inserted piston 111.

FIG. 4A: In this example of the small sample loop, the pump piston 111 is only inserted a short distance (almost a quarter length) into the pump volume 112. The fluidically coupled (not shown) sample loop can pick up 40 μL, and the pump piston 111 causes a volume change of 3.2 μL (32 μL net volume).

FIG. 4B: In this example of the large sample loop, the pump piston 111 can be inserted much farther (more than half length) into the pump volume 112, because the fluidically coupled sample loop can pick up 100 μL. The pump piston 111 causes a volume change of 20 μL (200 μL net volume). Because both dosing (or metering) devices 110 have the same dimensions it can be directly concluded to the inner volume (property) of the sample loops (as the element in the flow path).

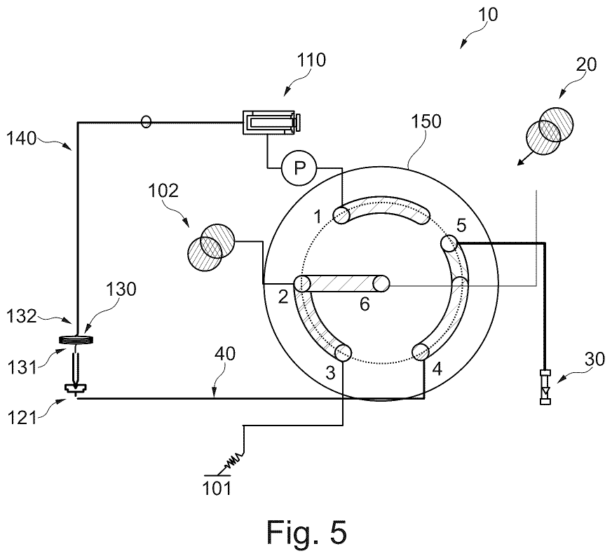

FIG. 5 shows schematically a second configuration of the analysis device or system 10 similar to the first configuration according to FIG. 2, according to an exemplary embodiment of the present disclosure. In contrast to FIG. 2, the fluid valve 150 is now switched such that the dosing (or metering) pump 110 is fluidically coupled with the sample separation device or unit 30 via the flow path 140 and the valve positions 4 and 5. The analytical pump 20 in this example is coupled to the flushing path via the valve position 6. In this configuration, the dosing (or metering) pump 110 is used instead of the analytical pump 20, in order to characterize a property of the sample separation device 30 as the element in the flow path.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the control device or control system 70 (or electronic processor-based computing device, system controller, controller, control unit, data processing unit, device for data processing, etc.) schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), or field-programmable gate arrays (FPGAs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the control device or control system 70 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

### REFERENCE SIGNS

10 Analysis device
20 Fluid drive, fluid drive device
25 Feeding device
27 Degasser
30 Sample separation device
40 Injector
50 Detector
60 Fractionator
70 Control device
101 Waste
102 Flushing pump
110 Dosing (or metering) device, dosing (or metering) pump
111 Pump piston
112 Pump volume
120 Sample needle
121 Needle seat
130 Element in the flow path, sample intake, sample loop
131 Inflow, inlet
132 Outflow, outlet
140 Flow path
150 Fluid valve

1. A method for characterizing a property of an element in a flow path of an analysis device, the method comprising:
changing the volume of a fluid in the element of the flow path to change the pressure in the flow path;
determining a pressure change in the flow path as a consequence of the volume change; and
characterizing the property of the flow path based on the determined pressure change and/or the volume change.

2. The method of claim 1, comprising at least partially closing an inflow and/or an outflow of the element in the flow path.

3. The method of claim 1, wherein the volume change comprises a volume reduction, and/or wherein the pressure change comprises a pressure increase.

4. The method of claim 1, comprising at least one of:
wherein the determining of the pressure change comprises a pressure measurement;
wherein the determining of the pressure change comprises a pressure measurement by a pressure sensor.

5. The method of claim 1, wherein the changing of the volume comprises a compressing and/or a temperature change.

6. The method of claim 1,
wherein the characterizing comprises at least one of the following regarding the element in the flow path: a verification; an identification; a mapping; an assigning; a distinguishing; a positioning-determining; a determining of a wiring; and/or
wherein the property comprises at least one of the following regarding the flow path the element in the flow path: a volume; a size; a type.

7. The method of claim 1, wherein the characterizing of the property further comprises comparing the determined pressure change and/or the volume change with a reference property and/or a reference element.

8. The method of claim 1, wherein the volume change is provided by movement of a pump piston in a pump volume of a pump.

9. The method of claim 1, wherein the volume change is provided by a metering device.

10. The method of claim 1, comprising estimating the volume change or a value range for the volume change.

11. The method of claim 1, wherein the element in the flow path comprises at least one selected from the group consisting of: a sample intake device; a sample loop; a trap column; a valve; a capillary; a conduit; a channel; a filter; a damper; and a separating column.

12. The method of claim 1, comprising at least one of the following features:
wherein the complete flow path or an area of the flow path is characterized;
wherein the flow path is arranged between a sample needle and a metering device;
wherein the flow path is arranged between a metering device and a sample separation unit;
wherein the flow path is arranged between a sample needle and an analytical pump;
wherein the flow path is arranged between a fluid drive device and a valve;
wherein the flow path is arranged between a fluid drive device and a valve, and the valve is switched such that an output of the flow path is at least temporarily closed;
wherein the flow path is arranged downstream of a fluid drive device;
wherein the flow path is arranged downstream of a fluid drive device, and the flow path at one ending is at least temporarily closed.

13. The method of claim 1,
wherein the fluid comprises at least one selected from the group consisting of: water; an organic solvent; a sample fluid; a mobile phase; a sample fluid injected into a mobile phase; a gas; and air; and/or
wherein the compressibility of the fluid is known.

14. The method of claim 1, comprising determining the compressibility of the fluid in the flow path.

15. The method of claim 14, wherein the determining of the compressibility comprises operating comprises a metering device, and the determining of the compressibility further comprises:
determining first volume difference and a first pressure difference at a first position;
determining a second volume difference and a second pressure difference at a second position;
determining the compressibility based on the first volume difference, the first pressure difference, the second volume difference, and the second pressure difference.

16. The method of claim 1, comprising at least one of the following features:
wherein the characterizing is carried out by an absolute measurement value or by a relative measurement value;
wherein the method regarding the analysis device is non-invasive;
wherein available equipment is used for the method;
wherein the method is carried out substantially without a human operator;
wherein the method regarding the analysis device is carried out in a remote operation.

17. A control device comprising at least a processor and a memory, wherein the control device is configured to control or perform the steps of the method of claim 1.

18. An analysis device for performing an analyzing method, the analysis device comprising:
the control device of claim 17;
a fluid drive device for driving a mobile phase and a fluidic sample injected into the mobile phase; and
a sample separation unit for separating the fluidic sample.

19. The analysis device of claim 18, comprising at least one of the following features:
the analysis device is configured for analyzing of at least one of a physical, chemical and/or biological parameter of the fluidic sample;
the analysis device is configured as a chromatography device;
the analysis device is configured as a microfluidic device;
the analysis device is configured as a nanofluidic device;
the sample separation unit is configured as a chromatographic separation device;
the fluid drive is configured for driving the mobile phase and the fluidic sample at a pressure selected from the group consisting of: a pressure of at least 500 bar; a pressure of at least 1000 bar; a pressure of at least 1200 bar; a pressure of at least 1500 bar; and a pressure of at least 2000 bar;
the analysis device comprises a detector for detecting the separated fluidic sample;
the analysis device comprises a fractionator for fractionating separated fractions of the fluidic sample.

20. A non-transitory computer-readable medium with instructions stored thereon, that when executed by a processor, control or perform the steps of the method of claim 1.
